(19) United States
(12) Patent Application Publication
(10) Pub. No.: US 2024/0407300 A1
(43) Pub. Date: Dec. 12, 2024

(54) FOIL WRAPPING DEVICE

(71) Applicant: ORKEL HOLDING AS, Fannrem (NO)

(72) Inventor: Öyvind Jonassen HAGEN, Trondheim (NO)

(21) Appl. No.: 18/716,901

(22) PCT Filed: Dec. 8, 2022
(86) PCT No.: PCT/NO2022/050285

§ 371 Date: Jun. 5, 2024

(30) Foreign Application Priority Data
Dec. 9, 2021 (NO) 20211484

(51) Int. Cl. A01F 15/07

(52) U.S. Cl. CPC A01F 15/071; A01F 2015/073; A01F 2015/0755

(57) ABSTRACT

Foil wrapping device for wrapping of round bales comprising a wrapping table (13A, 13B) and at least one wrapper arm (12, 12′) said wrapper arm (12, 12′) comprising a foil roll (14) arranged to wrap plastic foil around a bale on the wrapping table, as well as means arranged to rotate at least one of the wrapping table (13A, 13B) and the wrapper arm (12). The wrapper arm(s) (12) is/are arranged with an inclination in relation to the axis of the wrapping table. Furthermore, the wrapping table (13A, 13B) is shorter in the direction parallel with the powered rollers than a typical ball length, to allow an end section of a bale supported thereon to be unsupported.

The present invention concerns a foil wrapping device for cylindrical bales as indicated by the preamble of claim 1.

The wrapping device can either be an independent wrapper, or be implemented on a baling device.

### BACKGROUND

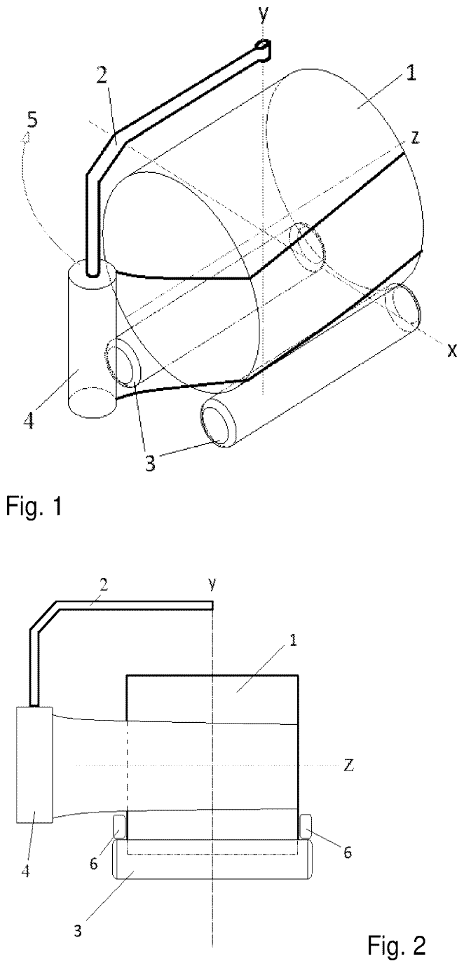

Conventional plastic foil bale wrapping devices have a supportive surface underneath the bale, often referred to as a wrapping table, and means of achieving relative rotation between the bale and at least one film roll. The relative rotation could either be due to a stationary bale, and a moving film roll, or vice versa. This movement must not be confused with the rotation the bale has around its own axis as will be explained in the figure discussion for FIG. 1. The present invention will be applicable to both these scenarios, and a combination of those. A device for stretching the film is often equipped on the film rolls in order to apply the film tightly without wrinkles, and with increased structural hold of the bale. The bale might be wrapped previously in either a net or a wider plastic film that covers the entire curved surface. The net or this wide plastic film is applied while the bale is in the chamber. It is still necessary to wrap the film further in order to seal the ends of the bale, as well as increasing the thickness at the curved surface. This secondary wrapping process is the one described in this device.

During wrapping the bale is slowly turned around its own axis on the wrapping table at a speed adapted to the rotational velocity film roll, to ensure a certain overlap of the foil from one turn to the next. Due to the geometry of the present wrapping method, where every layer of film will wrap the centre of the bales side surfaces, but only a small portion of the edges of said side surfaces, much more plastic film foil will be applied in the centre of the sides than on the edges. In order to obtain a foil wrapped bale with at least 6 layers of foil at every point of the bale, the centre of the sides of the bale is provided with approximately 27 layers of foil with this known arrangement, depending on the bale size (this is for bales with diameter 1150 mm and width 1200 mm) and standard width of the plastic film of 750 mm. This means that an excessive amount of plastic foil, and number of rotations of the film roll, is necessary to achieve a certain coverage, which is very unsuitable for the environment in terms of plastic consumption, but also for the efficiency of the wrapping process. The number of layers is essential for the preservation of the bales' material, where more layers gives a better preservation. If the bale is covered as the example above, with 27 layers in the central cluster, and 6 at the edges, the edges will be the point of leakage and thus the limiting factor for the quality of the bales' preservation.

Among prior art in this technical field, WO 2015/185 732 A1, EP 3 081 073 A1, and WO 2015/158 951 A1 should be mentioned.

### OBJECTIVE

It is thus an objective of the present invention to provide a device or a method of wrapping foil around a bale which is more effective in the sense that less amount of foil is consumed in the process, in addition to being more effective in terms of wrapping capacity and energy consumption.

### THE PRESENT INVENTION

The above indicated objective is achieved by the foil wrapping device according to the present invention, as defined by claim 1.

Preferred embodiments of the invention are disclosed by the dependent claims.

The invention applies film with an inclination a between the wrapper arm and the wrapping table of between 10 and 55 degrees. This gives an improved distribution of film due to decreased clustering in the centre of the bale's sides compared to regular wrapping methods, and apparatuses. This invention will rather apply more film towards the edges, thus reducing the centre clustering, which results in a lower total plastic consumption for a given numbers of applied film layers.

Using the foil wrapping device according to the present invention, the consumption of the standard 750 mm plastic foil is reduced by 56% compared to the consumption of today's commercial foil wrappers, according to full-scale test results. The amount of wide film used remains unchanged (wide film is the plastic film applied on the bales curved surface inside the chamber, and makes up about 26% of the total plastic film. This means the total plastic reduction is 40%, which is still a quite extraordinary improvement in bale wrapping. The number of necessary rotations is reduced from 27 to 11 with the new invention, thus improving the wrapping capacity vastly, as well as reducing necessary energy consumption.

FIG. 1 is a schematic, simplified 3d view of a wrapping table according to the prior art technology.

FIG. 2 is a schematic, simplified side view of the wrapping table of FIG. 1.

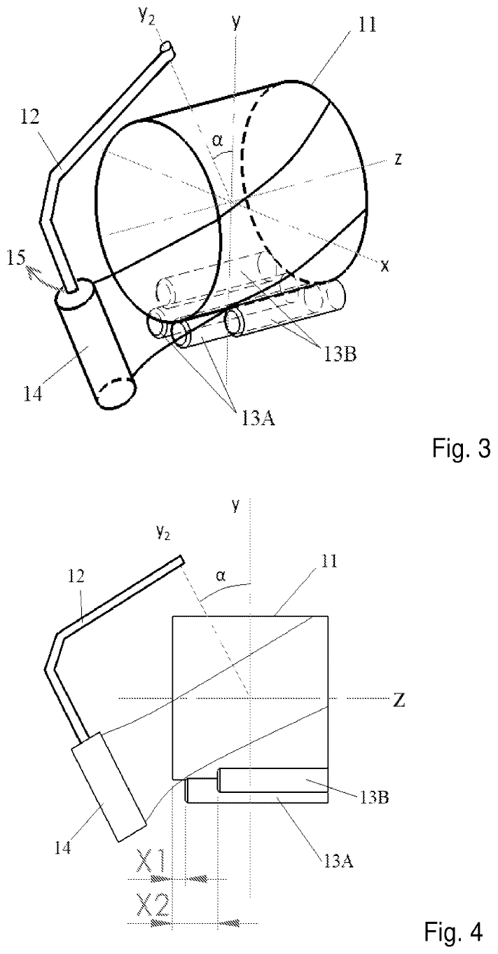

FIG. 3 is a schematic, simplified 3d view of a wrapping table according to the present invention.

FIG. 4 is a schematic, simplified side view of the wrapping table of FIG. 3.

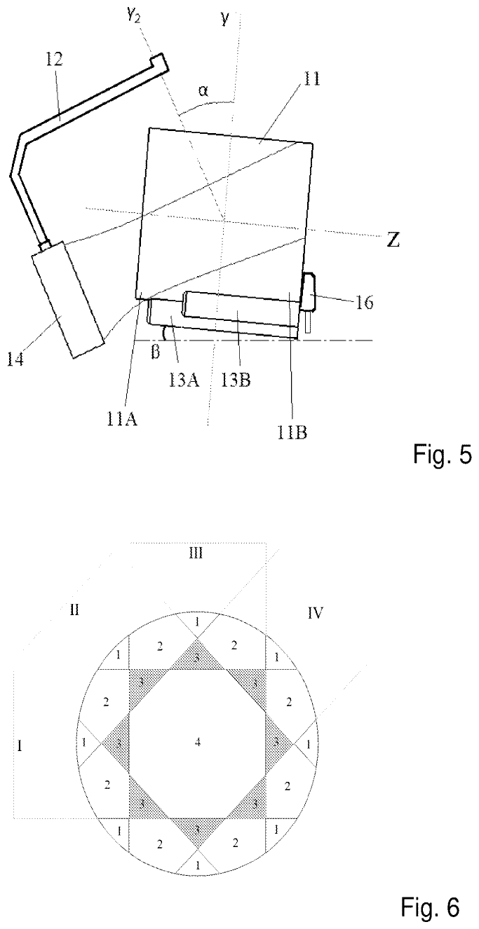

FIG. 5 is a schematic, simplified side view of a wrapping table according to the present invention.

FIG. 6 is a schematic, simplified side view of the film application according to the prior art technology.

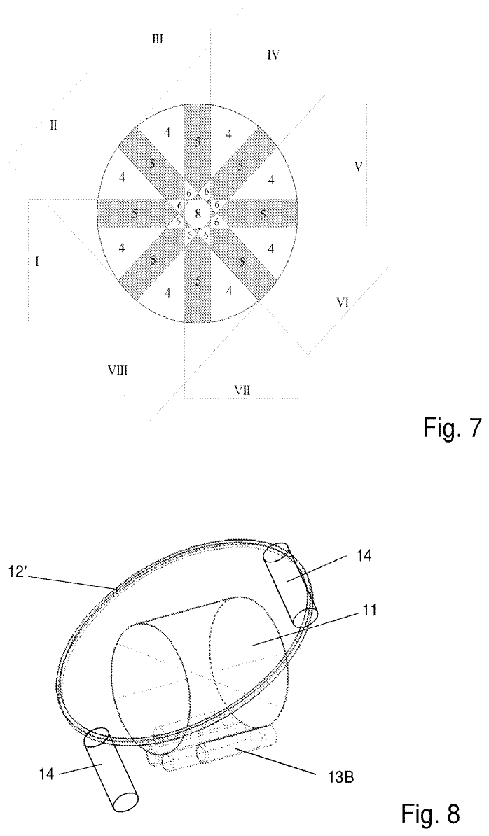

FIG. 7 is a schematic, simplified side view of the film application according to the present invention.

FIG. 8 is a schematic, simplified perspectival view of an alternative embodiment of a wrapping table according to the present invention.

By schematic and simplified is understood that the components are not necessarily shown with mutually correct dimensions and that certain components that may or will be present in a functioning system, such as power supply, hydraulic components etc., which are not part of the present invention, are omitted.

FIG. 1 shows a wrapping table according to the prior art, consisting of two rolls 3 under the bale 1. FIG. 1 also shows a wrapper arm 2 extending in parallel to the z axis of the wrapping table and a film roll 4 extending in parallel to the y-axis of the wrapping table. The bale is wrapped in plastic film by the film roll 4 by a relative rotational movement 5 between the film roll and the bale. Either one of the wrapping table and the film roll can be the movable unit, while the other is the stationary unit. Regardless of which unit that rotates, the bale 1 is rotated around its z axis by rotational movement of the rolls 3 to ensure a dispersed application of film. The relation between these two rotations determines the overlap, and can be adjustable.

FIG. 2 is a side view of FIG. 1. As shown, the entire extension of the bale 1 along the z axis is supported by the support rolls 3. The film roll 4 may rotate around the y axis while the wrapping table and the bale is stationary in relation to the y-axis, or alternatively the wrapping table 3 and the bale 1 may rotate around the y axis, while the film roll 2 is stationary. Thus, the film is applied perpendicular to the y-axis of the bale, and typically aimed towards the centre of the bale, although this is not always the case. Side supports 6 are shown at both sides of the wrapping table, their function being to prevent the bale from sliding off the wrapping table.

FIG. 3 is a schematic 3d-view of a bale 11 under wrapping according to the present invention. The wrapping table 13A, 13B shown comprises two long rollers 13A and two shorter rollers 13B, of which the two long rollers are optional. A wrapper arm 12 holding a roll of plastic film is also shown in FIG. 3. The distinct difference from the prior art technology is the angle α that separates the γ-axis of the wrapping table from the γ₂-axis perpendicular to the wrapper arm 12, the latter being parallel to the axis of the film roll 14. Prior art technology will, as already explained, have its relative movement between film roll and wrapping table with bale around the γ-axis, while according to the present invention, the relative movement will orbit around the γ₂-axis. The angle α can be any angle from 10-55 degrees, more preferably in the range from 15 to 45 degrees and most preferred in the range 25 to 35 degrees.

FIG. 4 is a schematic side view in accordance with FIG. 3, showing an additional distinction between the present invention and prior art technology, namely the reduced extension of the rollers 13A and 13B, supporting the bale and constituting the wrapping table. This is illustrated with distance X1 and X2 on the rollers, which have a restricted extension along the z-axis to avoid conflict with the plastic film being wrapped. The distances X1 and X2 are decided based upon the geometric factors of the system, hereunder the angle α and the vertical position of the shorter side rollers 13B.

FIG. 5 shows an illustrative example of how the wrapping table 13A, 13B and thereby the bale 11 could be tilted a certain angle β from horizontal orientation, an angle which can range from 0.5-30 degrees and most preferably about 4-6 degrees. This will lean the bale towards the side of attachment of the wrapping table 13A, 13B (the right hand side of the drawing), i.e. away from the side where the support roller(s) have reduced extension, and where the film is applied to the unsupported part 11A of the bale, thereby preventing the bale from accidentally sliding off the wrapping table. Gravity will pull the bale towards the other side 11B, where a side support 16 will prevent the bale from sliding further. This differs from the present technology where the bale lies preferably flat (horizontal), and is positioned by physical restraints, such as side supports as shown in FIG. 2. The reason for the one-sided only side support is to clear the space for the film wrap to be applied to the bale without interfering with other components.

FIG. 6 shows an illustrative example of the film application of prior art technology. Four layers of plastic film, marked with roman numerals (from I to IV), is applied on the bales end surface with a 45 degree angle displacement from each other. This will cover the 180 degrees of the bale, and due to its symmetry, is sufficient for comparison purposes, as the numbers of layers can be multiplied by two to achieve a full 360 degree round of wrapping. Despite a cluster of four layers in the centre of the side surface, certain points at the end are only covered by one layer. If 8 layers of plastic film is desired at every point of the bales surface, a total amount of 32 layers will be present in the central cluster according to this prior art technology. This is undesirable in relation to plastic consumption and wrapping capacity.

FIG. 7 shows an illustrative example of the film application with the present invention. The bale's end surface applied 8 layers of plastic film with a 45-degree angle displacement from, also marked with roman numerals from (I-VIII). Eight layers is necessary to complete a full 360 degree round of wrapping, for comparison with prior art technology. The central cluster is much smaller in extent, in addition to only being 8 layers in the middle cluster while the edges is covered by minimum 4 layers. If 8 layers of plastic film is desired at every point of the bales surface, a total amount of 16 layers will be present in the central cluster. This is half of what is necessary using the present-day wrapping method and illustrates the potential of benefits for the present invention.

FIG. 8 is a schematic 3d-view of an embodiments of a wrapping table bale according to the present invention. The difference from the embodiments shown in FIGS. 3 to 5, is the wrapper arm which has the shape of a continuous ring 12′, still with an inclination as illustrated in FIG. 3.

Furthermore, in the cases where the film roll 14 is stationary while the wrapping table is pivotal, numerous constructional means could be utilized to suspend the film roll 14.

The drive mechanism of the individual elements, such as the wrapper arms and the rolls of the wrapping table, can be based on one of several principles, such as electric, hydraulic, pneumatic, etc.

The present invention provides a solution in accordance with the above mentioned objectives in that it allows a more effective wrapping with which less foil material is required and less time is spent.

1. Foil wrapping device for wrapping of cylindrical bales comprising:
a wrapping table (13A, 13B) with a defined orientation and size, comprising powered rollers arranged to turn a bale having an axis (z) parallel with said rollers, and
at least one wrapper arm (12) with a defined axis (y₂), said wrapper arm (12) being arranged to hold a foil roll (14) in parallel with said axis (y₂) and
being arranged to wrap plastic foil around a bale localized on the wrapping table,
as well as means arranged to rotate
the wrapping table (13A, 13B) around the y-axis, or
the at least one wrapper arm (12) around the y₂ axis,
characterized in that the at least one wrapper arm (12) is arranged with an inclination (α) in relation to the axis of the wrapping table,
the wrapping table (13A, 13B) being shorter in the direction parallel with the powered rollers than a typical ball length, to allow an end section of a bale supported thereon to be unsupported.

2. Device as claimed in claim 1, wherein the mentioned inclination (α) is between 10 and 55 degrees.

3. Device as claimed in claim 1, wherein the mentioned inclination (α) is between 15 and 45 degrees.

4. Device as claimed in claim 3, wherein the inclination (α) is between 25 and 35 degrees.

5. Device as claimed in claim 1, wherein the wrapping table (13A, 13B) is tilted to an inclination (β) between 0.5-30 degrees towards the side of its attachment.

6. Device as claimed in claim 5, wherein the mentioned inclination (β) is about 5 degrees.

7. Device as claimed in claim 5, equipped with a side support (16) at the lower side of the inclined wrapping table.

8. Device as claimed in claim 1, wherein the device is provided with two (not shown) wrapper arms (12) having a common axis of rotation and being arranged symmetrically around the wrapping table.

9. Device as claimed in claim 1, wherein the wrapper arm(s) (12) is/are arranged stationary while the wrapping table (13A, 13B) is arranged to rotate around the y-axis.

10. Device as claimed in claim 1, wherein the wrapping table (13) is arranged stationary while the wrapper arm(s) is/are arranged to rotate around the y₂-axis.

11. Device as claimed in claim 1, wherein the film roll(s) (14) is/are suspended by a wrapper arm having the shape of a rotating ring (12′).

12. Device as claimed in claim 1, wherein the wrapping table is constituted by rollers (13A, 13B) which support the bale, the rollers having reduced extension along the z-axis.

13. Device as claimed in claim 1, wherein the wrapping table comprises two long rollers (13A) and two shorter rollers (13B).

14. Device as claimed in claim 13, wherein the two shorter rollers (13B) are side rollers.

15. Device as claimed in claim 12, wherein the reduced extension of the rollers is determined based upon geometric factors of the system, namely the angle α and the vertical position of the shorter side rollers (13B).

16. Device as claimed in claim 13, wherein the shorter rollers (13B) are vertically higher than the long rollers (13A).

17. Device as claimed in claim 1, the device configured to apply the film to an unsupported part of the bale.

18. Device as claimed in claim 5, the device configured to apply the film to an unsupported part of the bale.

19. Device as claimed in claim 13, the device configured to apply the film to an unsupported part of the bale.

20. Device as claimed in claim 19, wherein the mentioned inclination (α) is between 15 and 45 degrees.
